(19) United States
(12) Patent Application Publication
(10) Pub. No.: US 2006/0124765 A1
(43) Pub. Date: Jun. 15, 2006

(54) Fuel injection nozzle

(76) Inventors: Dirk Kothen, Augsburg (DE); Gertrud Meggenrieder, Aystetten (DE); Dietmar Pinkernell, Gablingen (DE); Andreas Stichnoth, Munchen (DE); Hakan Yalcin, Neu-Ulm (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/559,207

(22) PCT Filed: May 28, 2004
(86) PCT No.: PCT/EP04/05770

§ 371 Date: Dec. 2, 2005

(30) Foreign Application Priority Data
Jun. 3, 2003 (DE) 10324985.0

(51) Int. Cl. B05B 9/00

(52) U.S. Cl. 239/125; 239/132; 239/132.1; 239/132.3

(57) ABSTRACT

Disclosed is a fuel injection nozzle comprising a cooling duct (6) that is disposed in the final region of a housing (1), which faces the combustion chamber. In order to cool the zones that are subjected to high thermal stress, the cooling duct (6) is positioned closer to the bore (2) of the valve needle than to the external face of the housing (1) and is provided with a cross-sectional area that has a width corresponding to no more than the height which extends in the axial direction of the nozzle.

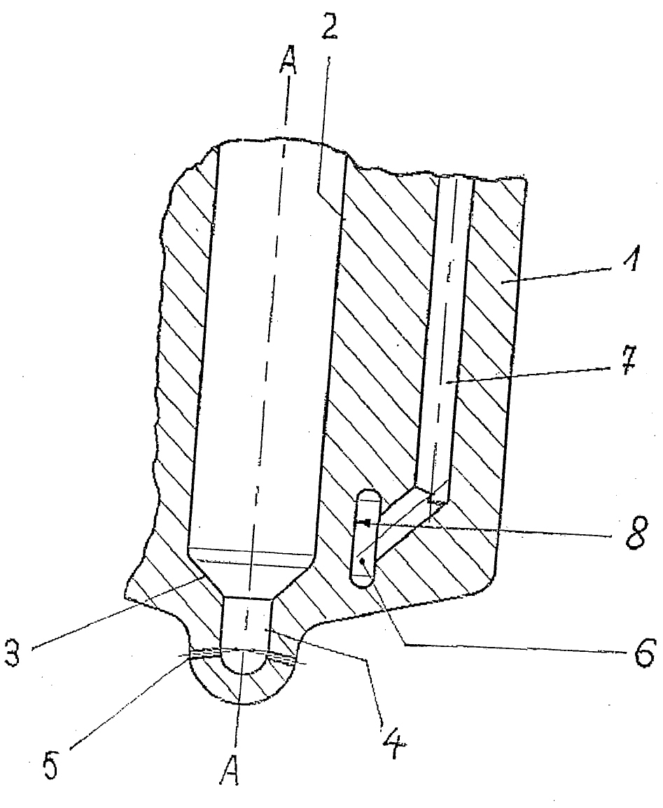

The invention relates to a fuel injection nozzle having a cooling duct which is arranged in the combustion chamber side end region of the housing.

The invention is based on the object of bringing about good cooling of the regions of the injection nozzle which are subjected to high thermal stress.

This is achieved according to the invention in that the cooling duct is arranged closer to the nozzle needle bore than to the outside of the housing and has a cross sectional face whose width is dimensioned so as to be at most equal to the height extending in the axial direction of the nozzle.

This measure allows the internal region of the nozzle to be cooled to a greater extent because the cooling medium can be brought closer to the parts which are subjected to high thermal stress. Also as a result of this, a relatively large wall surface of the cooling duct faces these parts. Furthermore, cold corrosion on the outside of the housing is avoided.

The width of the cooling duct is advantageously 0.1 to 0.9 times the height. According to one preferred embodiment, the width of the cooling duct is approximately 0.25 times the height.

The cooling duct preferably extends as far as the height of the nozzle needle seat on the combustion chamber side.

Further advantageous refinements and expedient developments of the superordinate measures are given in the remaining subclaims and can be found in the exemplary description given below with reference to the drawing.

The single FIGURE of the drawing shows a vertical section through the parts of an injection nozzle which are essential according to the invention.

The nozzle has a housing 1 in which a nozzle needle bore 2 with a nozzle needle seat 3 is arranged along the axis A-A of said nozzle. The nozzle needle bore 2 is continuous with a fuel prestorage space 4 which leads to injection bores 5 which project into the combustion chamber (not illustrated).

A cooling duct 6 is arranged in the housing 1. The width of this cooling duct here is approximately 0.25 times the height extending in the direction of the axis A-A. The width of the cooling duct 6 will generally be dimensioned to be at most equal to the height. The width will preferably be selected in a range from 0.1 to 0.9 of the height. A cooling duct which is formed in this way may be made to extend to close to the combustion chamber, thus extending into the end region of the nozzle which is subjected to the highest thermal stress. Furthermore, a large wall surface 8 of the cooling duct 6 which faces the internal region of the nozzle is made available for the transfer of heat to the cooling water.

The cooling duct 6 is supplied with cooling medium by a cooling medium inflow line 7. The cross sectional face of the cooling duct 6 here is approximately twice the cross sectional face of the cooling medium inflow line 7. As a result, a relatively high flow rate of the cooling medium and thus a relatively large rate of dissipation of heat is brought about. Dead water regions are also avoided with this design.

As is shown by the statements above, the invention is not restricted to the illustrated exemplary embodiment.

1-5. (canceled)

6. A fuel injection nozzle comprising a housing, the housing comprising:
a nozzle needle bore having a central axis and a needle seat;
an outside surface radially spaced from the axis; and
a cooling duct arranged around the bore, the cooling duct being closer to the bore than to the outside surface of the housing, the cooling duct having a cross-sectional area in a plane through the central axis, the cross-sectional area having a height in the axial direction and a width transverse to the axis, the width being less than the height.

7. The fuel injection nozzle of claim 6 wherein the width is 0.1 to 0.9 times the height.

8. The fuel injection nozzle of claim 7 wherein the width is approximately 0.25 times the height.

9. The fuel injection nozzle of claim 1 wherein the duct extends axially as far as the needle seat.

10. The fuel injection nozzle of claim 6 further comprising a cooling medium inflow line having a cross-sectional area where the inflow line meets the cooling duct, the cross-sectional area of the cooling duct being approximately twice the cross-sectional area of the inflow line.
